(19) United States
(12) Patent Application Publication
(10) Pub. No.: US 2014/0166769 A1
(43) Pub. Date: Jun. 19, 2014

(54) AUTOMATED DEVICE FOR THE APPLICATION OF AGRICULTURAL MANAGEMENT MATERIALS

(71) Applicant: Dow Agrosciences LLC, Indianapolis, IN (US)

(72) Inventor: Nick Kavardinas, Thessaloniki (GR)

(73) Assignee: DOW AGROSCIENCES LLC, Indianapolis, IN (US)

(21) Appl. No.: 13/804,067

(22) Filed: Mar. 14, 2013

Related U.S. Application Data
(60) Provisional application No. 61/739,589, filed on Dec. 19, 2012.

(51) Int. Cl. A01M 7/00

(52) U.S. Cl. CPC A01M 7/0089
USPC 239/1; 239/337; 239/70

(57) ABSTRACT

An apparatus and method for applying an agricultural management material to targeted area. Exemplary agricultural management materials include viscous materials.

### RELATED APPLICATIONS

This application claims the benefit of U.S. Provisional Patent Application Ser. No. 61/739,589, filed Dec. 19, 2012, titled AUTOMATED DEVICE FOR THE APPLICATION OF AGRICULTURAL MANAGEMENT MATERIALS, docket DAS-0284-01-US-E, the disclosure of which is expressly incorporated by reference herein.

This application is related to U.S. Provisional Patent Application Ser. No. 61/739,581, filed Dec. 19, 2012, titled MECHANICAL APPLICATOR FOR AGRICULTURAL MANAGEMENT MATERIALS, docket DAS-0290-01-US-E; U.S. Provisional Patent Application Ser. No. 61/739,605, filed Dec. 19, 2012, titled APPLICATION DEVICE DESIGNS FOR APPLYING AGRICULTURAL MANAGEMENT MATERIALS TO TARGETED SUBSTRATES, docket DAS-0285-01-US-E; and U.S. Provisional Patent Application Ser. No. 61/739,599, filed Dec. 19, 2012, titled EQUIPMENT DESIGNS FOR APPLYING AGRICULTURAL MANAGEMENT MATERIALS, docket DAS-0289-01-US-E, the disclosures of which are expressly incorporated by reference herein.

### FIELD

The present invention relates to methods and apparatus for delivering an agricultural management material and in particular to methods and apparatus for delivering a viscous pest control material to targeted substrates including one or more of agricultural crops, plants, structures, and substrates in the proximity thereof.

### BACKGROUND

Viscous materials are used as specialized substrates for delivering pheromones and insecticides into agricultural settings such as orchards, groves, plantations, vineyards, or onto surrounding areas with the purpose of effecting pest control or management in the agricultural area. Traditional pest control materials that are diluted with water and sprayed under pressure on to the crops or other plant substrate. However, this is not an option for more viscous materials, materials that are not miscible in water, or materials that are intended to remain as discrete, localized deposits on the target substrate. Methods and apparatus for applying highly viscous materials, such as for pest control and pest management, that results in high levels of product deposition, controlled deposition of discrete localized deposits, or both on the target plant are desired.

### SUMMARY

In an exemplary embodiment of the present disclosure, a device for delivering a viscous agricultural management material to a targeted area is provided. The device includes a container containing a supply of the viscous agricultural management material; a fluid conduit; a dispenser for dispensing a quantity of the viscous agricultural management material from the container into a loading area of the fluid conduit in response to a dispensing signal from at least one controller; a pressurized fluid source in fluid communication with the fluid conduit; a valve having a closed position in which pressurized fluid from the pressurized fluid source is not in communication with the loading area of the fluid conduit and an open position in which pressurized fluid from the pressurized fluid source is in communication with the loading area of the fluid conduit, the valve changing position in response to an air signal from the at least one controller; wherein when the valve is in the open position, the pressurized fluid directly contacts the viscous agricultural management material and pushes the viscous agricultural management material from the loading area out of the device towards the targeted area.

In another exemplary embodiment of the present disclosure, a method for delivering a viscous agricultural management material to a targeted area is provided. The method includes dispensing a quantity of the viscous agricultural management material from a container into a loading area of a fluid conduit; and opening an air valve positioned in a fluid connection between a pressurized source and the loading area of the fluid conduit, wherein opening the air valve causes a pressurized fluid to directly contact the viscous agricultural management material and push the viscous agricultural management material from the loading area towards the targeted area.

The above mentioned and other features of the invention, and the manner of attaining them, will become more apparent and the invention itself will be better understood by reference to the following description of embodiments of the invention taken in conjunction with the accompanying drawings.

### BRIEF DESCRIPTION OF THE DRAWINGS

FIG. 1 illustrates a portion of an exemplary embodiment of a material delivery device according to the present disclosure;

FIGS. 2A-2C illustrate the exemplary material delivery device of FIG. 1 expelling a quantity of a viscous material towards a targeted area;

FIG. 3 illustrates a side view of an exemplary embodiment of an material delivery device according to the present disclosure;

FIGS. 4A, and 4B illustrate a side view of the material delivery device of FIG. 3 with the side panel removed;

FIG. 5 illustrates the relationships between components of the material delivery device of FIG. 3 in an exemplary method of use; and

FIG. 6 is an exemplary method for using the material delivery device of FIG. 3.

### DETAILED DESCRIPTION OF THE DRAWINGS

The embodiments disclosed below are not intended to be exhaustive or to limit the invention to the precise forms disclosed in the following detailed description. Rather, the embodiments are chosen and described so that others skilled in the art may utilize their teachings. While the present disclosure is primarily directed to the application of viscous materials onto agricultural or other plant substrates, it should be understood that the features disclosed herein may also have application to the application and delivery of other materials to other targets.

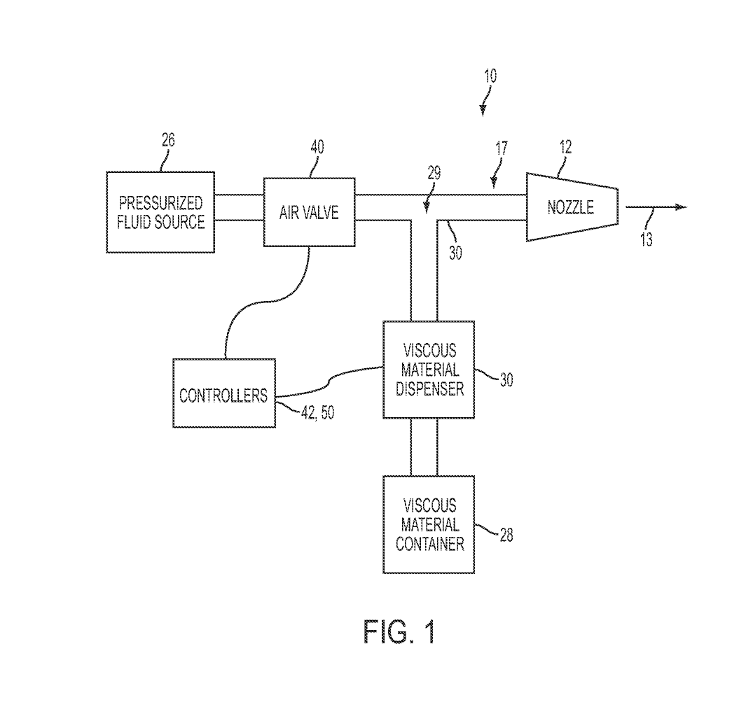

FIG. 1 illustrates a portion of an exemplary embodiment of a material delivery device 10 according to the present disclosure. Material delivery device 10 includes a fluid conduit 17 in fluid communication with an outlet nozzle 12 for delivering a predetermined quantity of a viscous pest control material to a targeted area. The predetermined quantity of viscous material is forced from nozzle 12 of material delivery device 10 in direction 13 by a quantity of pressurized fluid, such as compressed air. In one embodiment, material delivery device 10 applies an agricultural management material, such as a viscous material onto a targeted substrate. Exemplary agricultural management materials include pesticides, insecticides, pheromones, or other suitable viscous materials, onto a target. Suitable target substrates include trees, leaves, vines, stalks, and other suitable vegetation and plant substrates. Additional suitable target substrates include non-plant material in the area near the plant or crop, such as fence posts or other structures surrounding a field, orchard, plantation, or grove. In some embodiments, the material delivery device 10 reduces the amount of viscous material ending up in off-target locations like the ground, making a more efficient use of the viscous material.

In one embodiment, the present disclosure is directed to applying viscous agricultural management materials. Viscosity is a measure of the resistance of a fluid being deformed by either shear or tensile stress. Fluids with higher viscosity are observed as having a greater “thickness” or “internal friction,” while fluids with lower viscosity are observed as having a greater ease of movement or fluidity. In one embodiment, viscous materials include materials having a viscosity as low as about 1,000 cP, 2,000 cP, or 2,200 cP or as high as about 63,000 cP, 65,000, or 75,000 cP, or within any range defined by between any pair of the foregoing values. Exemplary methods of measuring viscosity include using a Brookfield DVI viscometer, available from Brookfield Engineering Laboratories, Inc., Middleboro, Mass. Exemplary test conditions include measuring the viscosity at 21° C. using a Brookfield DVI viscometer with a #6 or #7 spindle and a spindle speed of 100 rpm.

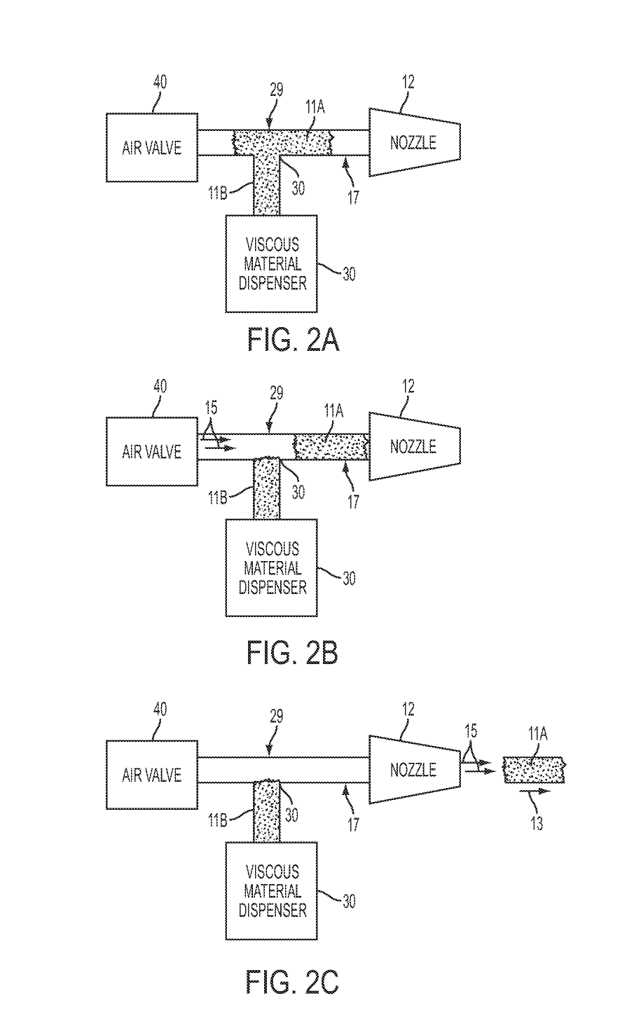

Material delivery device 10 further includes a viscous material container 28 containing the viscous material to be applied by material delivery device 10 and a pressurized fluid source 26 supplying a burst of pressurized fluid to eject the viscous material from material delivery device 10 through nozzle 12. (See FIGS. 2A-2C). In one embodiment, pressurized fluid source 26 is a compressed gas source, such as an air compressor, a canister of pressurized air, nitrogen, or other suitable gas or vapor, or a pressurized supply of water or other suitable liquid, or mixtures thereof.

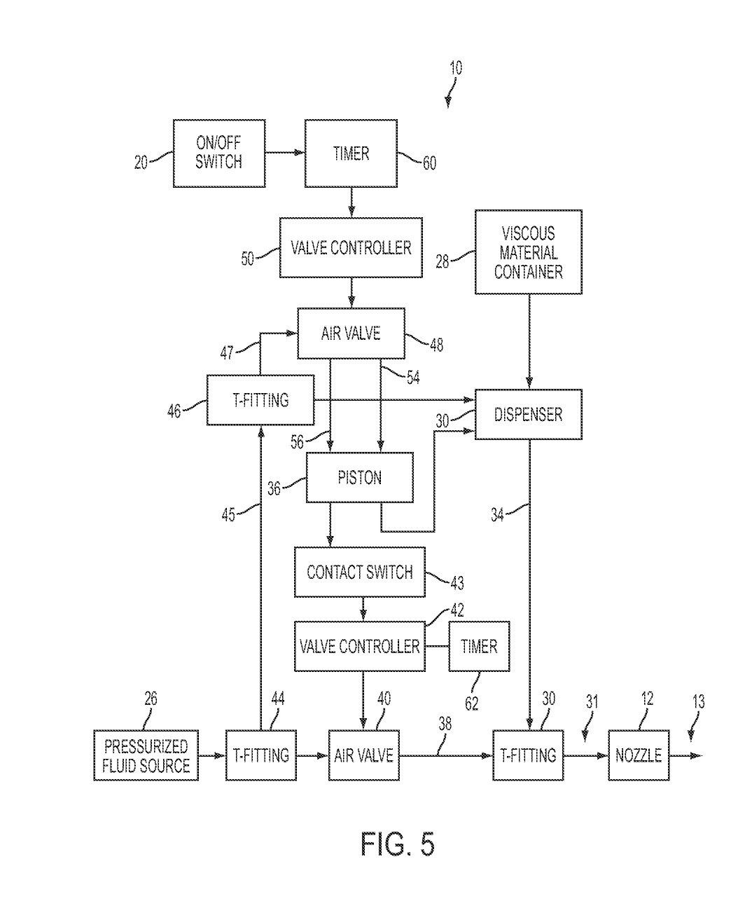

Viscous material container 28 is fluidly connected to a loading area 29 of fluid conduit 17 in material delivery device 10. In one exemplary embodiment, loading area 29 is positioned in a T-fitting 30. Viscous material dispenser 30, controlled by a controller, such as controller 50 (See FIG. 5), dispenses a predetermined quantity of the viscous material into loading area 29.

Pressurized fluid source 26 is fluidly connected to the loading area 29 of fluid conduit 17. Viscous material dispenser 30, controlled by a controller, such as controller 50 (See FIG. 5) dispenses a predetermined quantity of the viscous material into loading area 29. In one exemplary embodiment, viscous material dispenser 30 is a pump. Air valve 40, controlled by a controller, such as controller 42 (See FIG. 5), opens air valve 40 for a predetermined period of time to eject the material from loading area 29 through nozzle 12 in direction 13.

Referring next to FIGS. 2A-2C, the exemplary material delivery device of FIG. 1 is illustrated expelling a quantity of a viscous material towards a targeted area. In the illustrated embodiment, the viscous material 11 includes a first portion 11A dispensed into the loading area 29 and a second portion 11B not in the loading area 29. As illustrated in FIG. 2A, when air valve 40 is closed, viscous material dispenser 30 dispenses viscous material 11 such that the first portion 11A is positioned in the loading area 29. Once a predetermined amount of viscous material 11 has been dispensed, viscous material dispenser 30 stops dispensing viscous material 11, leaving some viscous material 11B outside the loading area 29.

As illustrated in FIG. 2B, when air valve 40 is opened, pressurized fluid, such as pressurized air indicated by arrows 15, directly contacts the first portion 11A of viscous material 11 positioned in the loading area 29. The pressurized fluid separates first portion 11A from second portion 11B and pushes first portion 11A towards nozzle 12. As illustrated in FIG. 2C, the pressurized fluid indicated by arrows 15 ejects the first portion 11A of viscous material out of the material delivery device in direction 13.

In one embodiment, the viscous material dispenser 30 is attached to the fluid passageway 17 connecting the air valve 40 and nozzle 12 at an angle of about 90°.

In some embodiments, the angle between the viscous material dispenser attachment to the T-fitting 30 and the fluid passageway 17 connecting the air valve 40 and nozzle 12 allows first portion 11A to be pushed towards nozzle 12 rather than back towards viscous material dispenser 30. In some embodiments, the viscous material dispenser resists pressure from pressurized fluid source 26 when air valve 40 is opened, allowing first portion 11A to be pushed towards nozzle 12 rather than back towards viscous material dispenser 30.

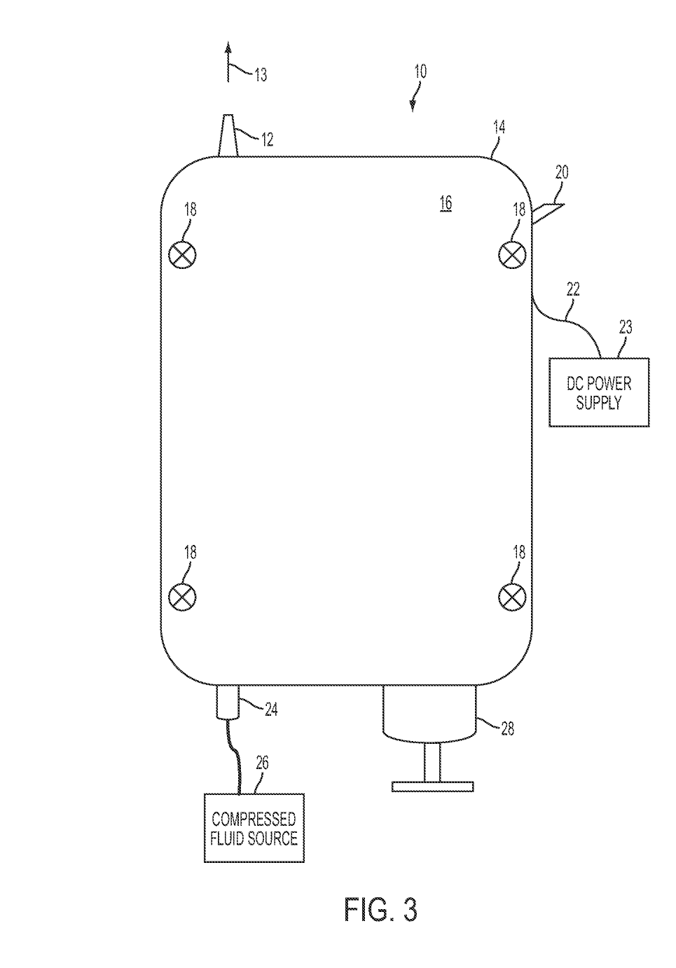

FIG. 3 illustrates an exemplary embodiment of a material delivery device 10 according to the present disclosure. Material delivery device 10 further includes a housing 14 surrounding at least a portion of the components of material delivery device 10. Illustratively, housing 14 includes a removable side panel 16 attached to housing through a plurality of fasteners 18.

Material delivery device 10 further includes a switch 20 attached to housing 14. In an exemplary embodiment, switch 20 is used to turn material delivery device 10 on and off. In another exemplary embodiment, switch 20 triggers the release of the predetermined quantity of viscous material through nozzle 12.

Material delivery device 10 illustratively further includes an electrical connection 22 to a power supply 23. Exemplary power supplies 23 include a direct current supply from a battery or transformer. In other embodiments, power supply 23 is included within housing 14. Material delivery device 10 also illustratively includes a connection 24 to a pressurized fluid source 26 supplying a burst of compressed air or other pressurized fluid to eject the viscous material from material delivery device 10 through nozzle 12. In other embodiments, pressurized fluid source 26 is included within housing 14.

Material delivery device 10 illustratively further includes container 28 containing the viscous material to be applied by material delivery device 10. In the illustrative embodiment, container 28 is partially positioned inside housing 14. In other embodiments, container 28 may be positioned entirely within housing 14 or entirely outside housing 14 and connected to nozzle 12 by a material supply line.

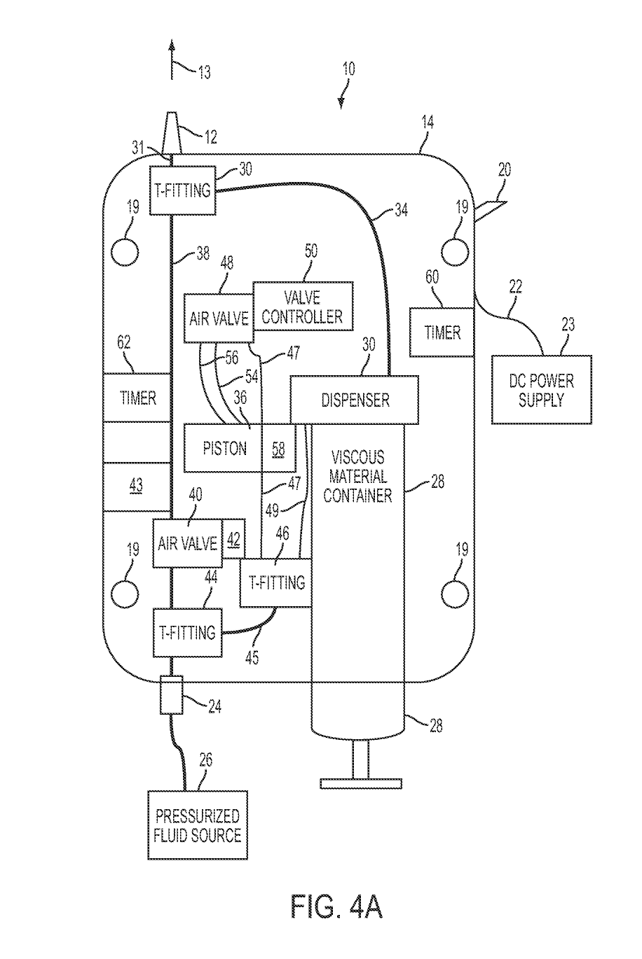

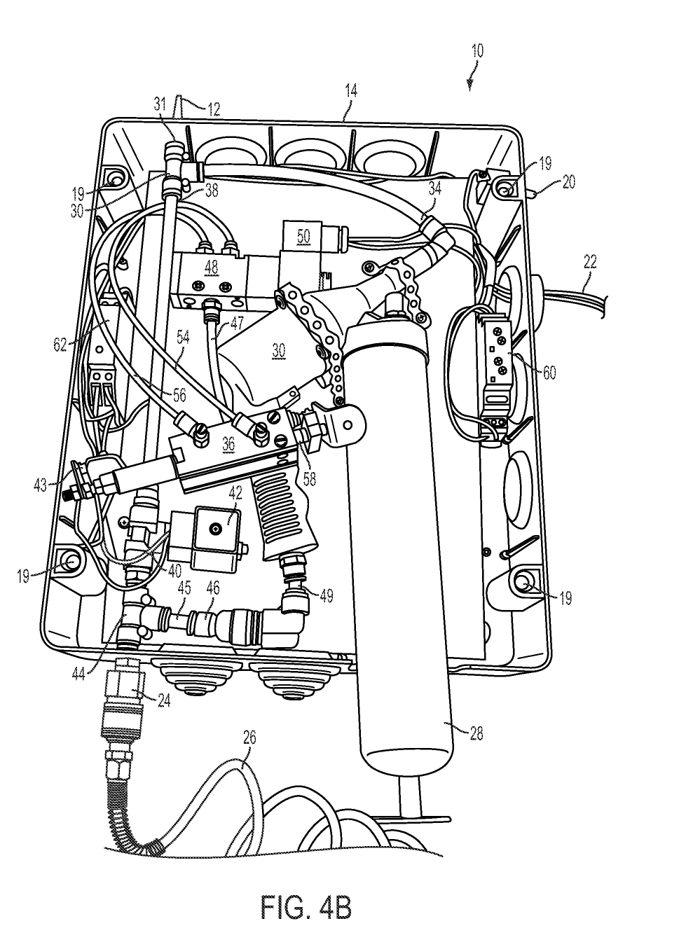

FIGS. 4A and 4B illustrate a side view of the material delivery device 10 of FIG. 3 with the side panel 16 of housing 14 removed. Receiving ports 19 are positioned to receive fasteners 18 when removable side panel 16 is attached to housing 14.

Nozzle 12 is attached to T-fitting 30 through a adaptor tube 31. Exemplary methods of attaching nozzle 12 to adaptor tube 31 include gluing, threading, bayonet-style connections, or other suitable connections. In one embodiment, nozzle 12 is substantially conical, frusto-conical, or cylindrical in shape. In a more particular exemplary embodiment, nozzle 12 is formed by cutting an opening in the end of a pipette tip, such as conical 1 ml GILSON pipette tip cut to form an opening about 5 mm in diameter at the tip of the pipette tip. In one exemplary embodiment, adaptor tube 31 is formed from plastic tubing.

T-fitting 30 has an exit attached to nozzle 12 through which a predetermined quantity of viscous material supplied from container 28 is propelled by a burst of compressed air supplied from pressurized fluid source 26. T-fitting 30 includes a first fitting inlet connected to container 28 providing viscous material to T-fitting 30 and a second fitting inlet connected to pressurized fluid source 26 providing compressed air to T-fitting 30. In an exemplary embodiment, pressurized fluid source 26 includes a supply of air pressurized at about 3.5 bar, although other suitable pressures may also be used. In one exemplary embodiment, pressurized fluid source 26 is connected to material delivery device 10 by connection 24, where connection 24 is an adaptor, such as an quick-connect adaptor. Connection 24 allows material delivery device 10 to be disconnected from pressurized fluid source 26 when not in use.

Container 28 containing the viscous material to be applied to the target is attached to dispenser 32. In one exemplary embodiment, dispenser 32 is a grease gun, such as NR AT-6036 available from AirMax. Dispenser 32 dispenses the viscous material from container 28 to T-fitting 30. In the illustrated embodiment, T-fitting 30 and dispenser 32 are fluidly connected through material tubing 34.

As illustrated in FIGS. 4A and 4B, dispenser 32 is operably coupled to piston 36 such that movement of piston 36 causes dispenser 32 to dispense the predetermined quantity of the viscous material through material tubing 34 and into T-fitting 30. In one exemplary embodiment, material tubing 34 is formed from plastic tubing, such as 7 mm plastic tubing. An exemplary piston 36 is a robotic piston such as model MKJ 20x30-25 available from Airtac.

As further illustrated in FIGS. 4A and 4B, the second fitting inlet of T-fitting 30 is fluidly connected to pressurized fluid source 26 through air tubing 38. In one exemplary embodiment, air tubing 38 comprises a brass tube about 8 mm in diameter, although other suitable materials and sizes for conveying compressed air may also be used. Flow of air through air tubing 38 is controlled by air valve 40. Air valve 40 is moveable between an open configuration allowing air to flow through air tubing 38 and a closed configuration preventing air from flowing through air tubing 38. An exemplary air valve 40 is an air switch, such as model D263DVG available from M&M International. When activated by valve controller 42, air valve 40 opens and releases pressure from pressurized fluid source 26 to the air tubing 38.

Valve controller 42 controls the movement of air valve 40 between the open and closed configurations. An exemplary valve controller 42 is an electromagnetic valve such as model D263DVG available from M&M International.

As illustrated in FIGS. 4A and 4B, T-fitting 44 is positioned between air valve 40 and the connection 24 to pressurized fluid source 26. T-fitting 44 includes a first fitting outlet fluidly connected to air valve 40 and air tubing 38 and a second fitting outlet fluidly connected to T-fitting 46. T-fitting 44 is connected to T-fitting 46 by air tubing 45. T-fitting 46 includes a first fitting outlet fluidly connected to dispenser 32 and a second fitting outlet fluidly connected to air valve 48. T-fitting 46 is connected to air valve 48 by air tubing 47 and to dispenser 32 by air tubing 49.

Air valve 48 is connected to piston 36 and is controlled by valve controller 50. Air valve 48 is connected to piston 36 by air tubing 54 and air tubing 56. Air valve 48 has a first position in which air is allowed to flow between air tubing 47 and air tubing 54 and a second position in which air is allowed to flow between air tubing 47 and air tubing 56. Valve controller 50 controls the configuration of air valve 48 between the first and second positions. In one embodiment, valve controller 50 and air valve 48 are a unitary component. An exemplary unitary component for air valve 48 and valve controller 50 is an electromagnetic valve, such as model NR EV528 SP00 available from Air Block.

In one exemplary embodiment, air tubing 45 and air tubing 47 are formed from plastic tubing, such as 6 mm diameter plastic tubing. In one exemplary embodiment, air tubing 54 and air tubing 56 are formed from plastic tubing, such as 4 mm diameter plastic tubing. Other suitable sizes and materials may also be used.

In the illustrated embodiment, when air valve 48 is in the first position, pressurized air is applied through air tubing 54 to an air chamber on a first side of piston 36 while an air chamber on the opposite side of piston 36 is exhausted, causing piston 36 to move to the dispensing position to cause dispenser to dispense the viscous material from container 28. Illustratively, when piston 36 moves from a non-dispensing position to a dispensing position, piston 36 depresses a trigger 58 on dispenser 32. When air valve 48 is in the second position, pressurized air is applied through air tubing 56 to the air chamber on the opposite side of piston 36 while the air chamber of the first side of piston 36 is exhausted, causing piston 36 to move to the non-dispensing position. Illustratively, piston 36 releases pressure on trigger 58, in turn stopping dispenser 32 from dispensing the viscous material from container 28. Further, when piston 36 returns to the non-dispensing position, piston 36 touches contact switch 43, activating valve controller 42 to move air valve 40 to the open position. An exemplary contact switch 43 is an electric switch such as model VS10N061C, available from Alpha3 Manufacturing Limited. When activated, contact switch 43 also activates second timer switch 62.

In the illustrated embodiment, material delivery device 10 further includes a first timer switch 60 and a second timer switch 62. First timer switch 60 includes a first timer functionality that regulates the length of time valve controller 50 opens air valve 48. This first functionality sets the size of the predetermined amount of viscous material that flows into T-fitting 30, where a longer time corresponds to a larger amount of viscous material and a shorter time corresponds to a smaller amount of viscous material. In the illustrated embodiment, first timer switch 60 further includes a second timer functionality that regulates the rate or frequency of movements of piston 36. This second functionality sets the rate or frequency at which dollops of the viscous material are formed in T-fitting 30 to be ejected from material delivery device 10 by a burst of compressed air, where a longer time corresponds to a lower frequency or lower rate and a shorter time corresponds to a higher frequency or higher rate. An exemplary first timer switch 60 is model MT-TER-17S-11-9240, available from Relpol. Second timer switch 62 activates valve controller 42 to open air valve 40 for a predetermined time. This sets the length of time of the burst of air expelling the dollop of viscous material from material delivery device 10, where a longer time corresponds to a longer burst of air and a shorter time corresponds to a shorter burst of air. An exemplary timer switch 62 is model 642UX available from SELECTRON Process Controls

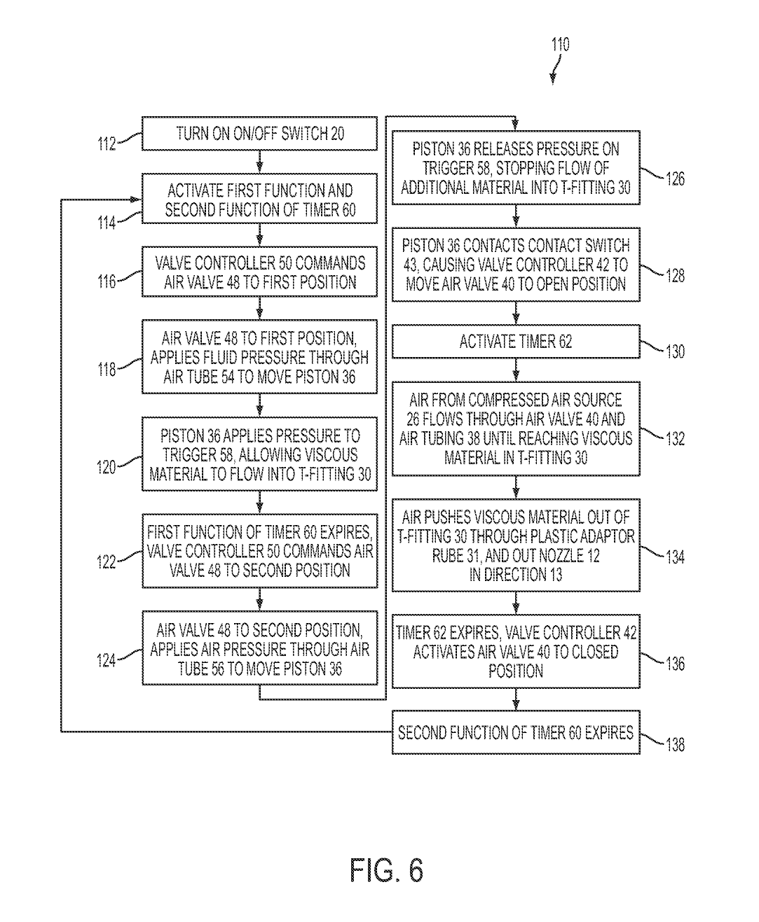

An exemplary method of use of material delivery device is provided with reference to FIGS. 5 and 6. FIG. 5 illustrates the operable relationships between components of material delivery device 10. FIG. 6 illustrates an exemplary process 110 for applying a viscous material from container 28 to a targeted area, such as a plant, vine, tree, vegetation, or other suitable target.

Referring to FIGS. 5 and 6, on/off switch 20 is first turned on in block 112. In block 114, on/off switch 20 activates first timer switch 60. First timer switch 60 has two functions. The first function of first timer switch 60 controls the size of the dollop of viscous material injected into T-fitting 30. The second function of first timer switch 60 controls the frequency of dollops being injected into T-fitting 30. Corresponding to the first function, as shown in block 116, first timer switch 60 activates valve controller 50 to move air valve 48 to the first position. The second function is indicated by the arrow returning to block 114 from block 138.

As shown in block 118, valve controller 50 moves air valve 48 to the first position, which applies air pressure through air tube 54 to move piston 36 from a non-dispensing position to a dispensing position. This movement, as shown in block 120, applies pressure to trigger 58 of dispenser 32. Applying pressure to trigger 58 causes viscous material to flow out of container 28, through material tubing 34, and into T-fitting 30. In one embodiment, material tubing 34 is filled with the viscous material prior to the start of process 110. In this embodiment, applying pressure to trigger 58 causes additional viscous material to flow out of container 28 and enter material tubing 34. The flow of additional viscous material into material tubing 34 pushes some material into T-fitting 30.

As shown in block 122, once the first function of first timer switch 60 expires, valve controller 50 activates to the second position. As shown in block 124, this moves air valve 48 to the second position, stopping the application of pressure to piston 36 through air tube 54. Moving air valve 48 to the second position further applies pressure to piston 36 through air tube 56 which moves piston 36 from the dispensing position to the non-dispensing position. As shown in block 126, the movement of piston 36 to the non-dispensing position results in a release of pressure on trigger 58, which in turn stops the flow of the viscous material into T-fitting 30. As illustrated in blocks 114 to 126, the length of first timer switch 60 determines the amount of viscous material in T-fitting 30. In one exemplary embodiment, first timer switch 60 is set to a time resulting in about 1.2 grams of material being released into T-fitting 30.

As shown in block 128, as piston 36 returns to the non-dispensing position, it contacts contact switch 43. Upon being touched by piston 36, contact switch 43 activates valve controller 42 to move air valve 40 to the open position and activates second timer switch 62, as shown in block 130.

As shown in block 132, moving air valve 40 to the open position allows air from pressurized fluid source 26 to flow through air valve 40 and air tubing 38 until reaching the viscous material extruded into T-fitting 30. The pressure of the compressed air pushes viscous material out of T-fitting 30 through adaptor tube 31 and out nozzle 12 in direction 13 (see FIG. 1C), as shown in block 134. In some embodiments, the angle of T-fitting 30 allows the viscous material to be pushed towards nozzle 12 rather than back towards viscous material dispenser 30. In some embodiments, the viscous material dispenser 30 resists pressure from pressurized fluid source 26 when air valve 40 is opened, allowing first portion 11A to be pushed towards nozzle 12 rather than back towards viscous material dispenser 30.

As shown in block 136, as second timer switch 62 expires, valve controller 42 adjusts air valve 40 back to the closed position, stopping the flow of compressed air through the material delivery device 10. The length of second timer switch 62 can be adjusted to length of the burst of compressed air that pushes the dollop of viscous material out of nozzle 12 of material delivery device 10.

Upon the expiration of second function of first timer switch 60, as shown in block 138, the process 110 returns to block 114, where the process repeats with a next dollop of material from container 28. The length of the second function of first timer switch 60 can be adjusted to change the frequency with which material delivery device 10 emits the dollops of viscous material.

While this invention has been described as relative to exemplary designs, the present invention may be further modified within the spirit and scope of this disclosure. Further, this application is intended to cover such departures from the present disclosure as come within known or customary practice in the art to which this invention pertains.

1. A device for delivering a viscous agricultural management material to a targeted area, the device comprising:
a container containing a supply of the viscous agricultural management material;
a fluid conduit;
a dispenser for dispensing a quantity of the viscous agricultural management material from the container into a loading area of the fluid conduit in response to a dispensing signal from at least one controller;
a pressurized fluid source in fluid communication with the fluid conduit;
a valve having a closed position in which pressurized fluid from the pressurized fluid source is not in communication with the loading area of the fluid conduit and an open position in which pressurized fluid from the pressurized fluid source is in communication with the loading area of the fluid conduit, the valve changing position in response to a fluid signal from the at least one controller;
wherein when the valve is in the open position, the pressurized fluid directly contacts the viscous agricultural management material and pushes the viscous agricultural management material from the loading area out of the device towards the targeted area.

2. The device of claim 1, further comprising:
a piston moveable between a dispensing position and a non-dispensing position, wherein when the piston is in the dispensing position, the dispenser dispenses the viscous agricultural management material from the container into the loading area, and when the piston is in the non-dispensing position, the at least one controller changes the position of the valve from closed to open.

3. The device of claim 2, further comprising a timer switch in communication with the at least one controller, the timer switch configured to be activated by the piston moving from the dispensing position to the non-dispensing position, the timer switch configured to transmit a signal to the at least one controller at predetermined intervals, the at least one controller configured to change the position of the valve from open to closed in response to receiving the signal from the timer switch.

4. The device of claim 2, wherein the dispenser further includes a trigger configured such that applying pressure to the trigger dispenses material from the dispenser, the piston applying pressure to the trigger when the piston is in the dispensing position.

5. The device of claim 1, wherein the at least one controller includes at least one timer switch controlling the dispensing signal and at least one timer switch controlling the fluid signal.

6. The device of claim 1, wherein the pressurized fluid source is a compressed air source.

7. The device of claim 1, further comprising a first timer switch in communication with the at least one controller, the first timer switch configured to transmit a first signal to the at least one controller at predetermined intervals, the at least one controller configured to transmit the dispensing signal in response to receiving the first signal from the first timer switch.

8. The device of claim 7, wherein the first timer switch is further configured to transmit a second signal to the at least one controller at predetermined intervals, the at least one controller configured to stop dispensing a quantity of the viscous agricultural management material from the container into a loading area in response to receiving the second signal from the first timer switch.

9. The device of claim 1, wherein the viscous agricultural management material has a viscosity from about 2,000 cP to about 63,000 cP.

10. A method of applying a viscous agricultural management material to a targeted area, the method comprising:
dispensing a quantity of the viscous agricultural management material from a container into a loading area of a fluid conduit; and
opening a fluid valve positioned in a fluid connection between a pressurized source and the loading area of the fluid conduit, wherein opening the fluid valve causes a pressurized fluid to directly contact the viscous agricultural management material and push the viscous agricultural management material from the loading area towards the targeted area.

11. The method of claim 10, wherein the dispensing step further comprises:
moving a piston from a non-dispensing position to a dispensing position; and
moving the piston from the dispensing position to the non-dispensing position;
wherein when the piston is in the dispensing position, a dispenser dispenses the viscous agricultural management material from the container into the loading area, and when the piston is in the non-dispensing position, the dispenser stops the dispensing of the viscous agricultural management material into the loading area.

12. The method of claim 11, further comprising the step of:
transmitting a signal when the dispenser moves from the dispensing position to the non-dispensing position, wherein the opening step is performed in response to receiving the signal.

13. The method of claim 12, wherein moving the piston from the dispensing position to the non-dispensing position further activates a timer, and further comprising:
transmitting with the timer a signal at a predetermined interval after being activated; and
closing the valve in response to receiving the signal from the timer switch.

14. The method of claim 11, further comprising:
transmitting at predetermined intervals a dispensing signal, wherein the piston is moved from the non-dispensing position to the dispensing position in response to receiving the dispensing signal.

15. The method of claim 14, further comprising:
transmitting at predetermined intervals a stop signal, wherein the piston is moved from the dispensing position to the non-dispensing position in response to receiving the stop signal.

16. The method of claim 10, wherein the pressurized fluid is compressed air.

17. The method of claim 10, wherein the viscous agricultural management material is a pest control material.

18. The method of claim 10, wherein the viscous agricultural management material has a viscosity from about 2,000 cP to about 63,000 cP.

19. The method of claim 10, wherein the viscous agricultural management material has a viscosity from about 1,000 cP to about 75,000 cP.
